(19) United States
(12) Patent Application Publication
(10) Pub. No.: US 2026/0357927 A1
(43) Pub. Date: Nov. 12, 2026

(54) PIPELINE COMPRISING AT LEAST ONE ADHESIVE-BONDING CONNECTION SYSTEM COAXIALLY CONNECTING A CONDUIT AND A CONNECTING ENDPIECE

(71) Applicant: Airbus Operations SAS, TOULOUSE (FR)

(72) Inventors: Gerard MILLET, TOULOUSE (FR); Stephane SAINT-AROMAN, TOULOUSE (FR)

(21) Appl. No.: 19/666,634

(22) Filed: May 4, 2026

(30) Foreign Application Priority Data
May 6, 2025 (FR) FR2504811

(51) Int. Cl. F16L 13/10; B29C 65/00

(52) U.S. Cl. CPC F16L 13/103; B29C 66/5344

(57) ABSTRACT

A pipeline with at least one adhesive-bonding connection system coaxially connecting a conduit and a connecting endpiece. The two are connected with a connection system having at least one receptacle configured to accommodate a region of adhesive connecting the conduit and the connecting endpiece. Each receptacle is delimited by an edge-face incorporated into the conduit, the connecting endpiece, or a spacer element. The outer surface of the conduit and the inner surface of the connecting endpiece have substantially the same diameter or the connection system includes a spacer element located at least partially between the conduit and the connecting endpiece, simultaneously in contact with these two elements.

### CROSS-REFERENCES TO RELATED APPLICATIONS

This application claims the benefit of French Patent Application Number FR2504811, filed on May 6, 2025, the entire disclosure of which is incorporated herein by way of reference.

### FIELD OF THE INVENTION

The present application relates to a pipe comprising at least one adhesive-bonding connection system coaxially connecting a conduit and a connecting endpiece.

### BACKGROUND OF THE INVENTION

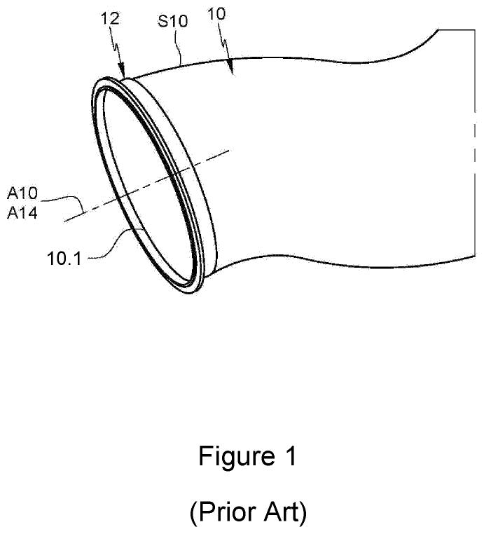

According to one embodiment visible in FIGS. 1, 2 and 3, a pipe comprises a conduit 10 which has at least a first end 10.1 and a connecting endpiece 12 located around the conduit 10, at its first end 10.1. The conduit 10 has a cylindrical outer surface S10 which has a conduit axis A10.

The connecting endpiece 12 comprises:
a sleeve 14 which has a sleeve axis A14, an inner surface S14 facing towards the conduit 10 and an outer surface S14′ and which extends between first and second ends 14.1, 14.2, and
a collar 16 positioned at the first end 14.1 of the sleeve 14, protruding with respect to the outer surface S14′.

According to one arrangement, the first end 14.1 of the sleeve 14 protrudes slightly with respect to the first end 10.1 of the conduit 10.

The conduit 10 and the connecting endpiece 12 are connected by a layer of adhesive 18 interposed between the conduit 10 and the connecting endpiece 12. In order to accommodate this layer of adhesive 18, the inner surface S14 of the sleeve 14 is spaced apart from the outer surface S10 of the conduit 10.

In order to obtain an optimal connection between the conduit 10 and the connecting endpiece 12, the layer of adhesive 18 must have a substantially (+/−10%) constant thickness over the circumference of the conduit 10, the conduit and sleeve axes A10, A14 having to be coaxial.

According to one operating procedure, a method for assembling the conduit 10 and the connecting endpiece 12 comprises a step of preparing the outer and inner surfaces S10, S14 of the conduit 10 and the sleeve 14 in contact with the layer of adhesive 18, a step of applying an adhesive in the pasty or liquid state to at least one surface from among the inner and outer surfaces S10, S14, a step of positioning the connecting endpiece 12 around the conduit 10, then a step of curing the adhesive in order to obtain the layer of adhesive 18 and a solid connection between the conduit 10 and the connecting endpiece 12.

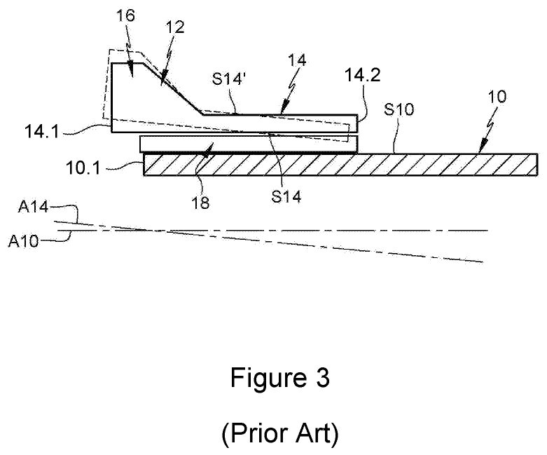

According to this operating procedure, it is difficult to correctly position the connecting endpiece 12 with respect to the conduit 10 during the positioning step and/or the connecting endpiece 12 can move with respect to the conduit 10 during the curing step. In both cases, at the end of the assembly method, the connecting endpiece 12 is not correctly positioned with respect to the conduit 10 such that the conduit and sleeve axes A10, A14 are not coaxial (as illustrated in FIG. 3 in dash-dotted lines) and/or the layer of adhesive 18 does not have a substantially constant thickness around the conduit 10.

Patent application US 2009/014121 A1 discloses a device which has a pipe joint made up of a first pipe with a cavity, a second pipe with an insertion section, annular channels forming a keyway, and a flanged annular ring for assembly using an adhesive. However, this solution does not satisfactorily address the problem of obtaining, after a simple assembly method, strictly coaxial axes and an adhesive-bonding connection system of perfectly uniform thickness over the entire circumference without needing to use complex additional annular components.

Patent application EP 2 255 954 A1 discloses a device which has a mixed assembly for snap-fastening and adhesively bonding ends of two tubes, involving a partial fitting, the injection of an adhesive, then a final fitting causing snap-fastening and compression of the adhesive. However, this solution does not satisfactorily address the problem of retaining perfect coaxiality and obtaining a layer of adhesive of constant thickness without requiring a snap-fastening profile requiring a significant insertion force.

Known lastly according to patent application U.S. Pat. No. 5,486,024 A is a device which has a sleeve for joining pipe ends, comprising annular elements for centering the pipes and sealing the annular space, and also a radially extending protrusion. However, this solution does not satisfactorily address the problem of providing specific receptacles delimited by edge-faces to confine regions of adhesive of uniform thickness between a conduit and a connecting endpiece of substantially identical diameters.

### SUMMARY OF THE INVENTION

The present invention aims to remedy all or some of the drawbacks of the prior art.

To this end, in at least one aspect, the present invention presents a pipeline comprising:
a conduit which has a first end, an outer surface, and a first axis;
an connecting endpiece positioned at the first end of the conduit, the connecting endpiece having an inner surface facing towards the conduit and a second axis; and,
a connection system connecting the conduit and the connecting endpiece and comprising a receptacle positioned between the conduit and the connecting endpiece, around the conduit, the receptacle configured to accommodate a region of adhesive connecting the conduit and the connecting endpiece,
wherein the outer surface of the conduit and the inner surface of the connecting endpiece have substantially a same diameter or the connection system comprises a spacer ring interposed between the conduit and the connecting endpiece, the spacer ring extending all the way around the conduit and having a substantially constant thickness, a first surface facing towards the conduit and in contact with the outer surface, and a second surface facing towards the connecting endpiece and in contact with the inner surface, and
wherein the receptacle of the connection system comprises a plurality of receptacles regularly distributed around the conduit, provided at the outer surface of the conduit and opening out at the first end of the conduit, each receptacle of the plurality of receptacles delimited by an edge-face incorporated into at least one element selected from the conduit, the connecting endpiece, and the spacer ring.

The plurality of receptacles may be separate and spaced apart from one another.

The plurality of receptacles may be connected to one another. The edge-faces of the plurality of receptacles form an undulation over an entire circumference of the conduit or the connecting endpiece.

In at least one aspect, the present invention may also be generally characterized as providing a pipeline which has:
at least one conduit which has a first end, at least an outer surface and a first axis,
at least one connecting endpiece, positioned at the first end of the conduit, which has at least an inner surface facing towards the conduit and a second axis,
at least one connection system connecting the conduit and the connecting endpiece and comprising at least one receptacle positioned between the conduit and the connecting endpiece, around the conduit, said receptacle being configured to accommodate a region of adhesive connecting the conduit and the connecting endpiece, the outer surface of the conduit and the inner surface of the connecting endpiece having substantially the same diameter or the connection system comprising at least one spacer element, at least partially interposed between the conduit and the connecting endpiece, having a first surface facing towards the conduit and in contact with the outer surface thereof and a second surface facing towards the connecting endpiece and in contact with the inner surface thereof, and
said at least one receptacle being delimited by at least one edge-face incorporated into at least one element from among the conduit, the connecting endpiece and said at least one spacer element, characterized in that the receptacles are provided at the outer surface of the conduit and open out at the first end of the conduit.

According to another feature, the connection system comprises a plurality of receptacles regularly distributed around the conduit. According to another feature, the receptacles are provided at the inner surface of the connecting endpiece and/or the outer surface of the conduit.

According to one embodiment, the receptacles are provided at the inner surface of the connecting endpiece and open out at an end of the connecting endpiece that is furthest away from the first end of the conduit.

According to another embodiment, the receptacles are provided at the outer surface of the conduit and open out at the first end of the conduit.

According to another configuration, the connection system comprises a spacer ring interposed between the conduit and the connecting endpiece, said spacer ring extending all the way around the conduit, having a substantially constant thickness and having a first surface facing towards the conduit and in contact with the outer surface thereof and a second surface facing towards the connecting endpiece and in contact with the inner surface thereof.

According to another configuration, the connection system comprises multiple spacer elements which each have a first surface facing towards the conduit and in contact with the outer surface thereof and a second surface facing towards the connecting endpiece and in contact with the inner surface thereof, the various spacer elements having identical thicknesses.

According to another feature, each spacer element comprises first and second branches which are substantially parallel to one another and a base connecting the first and second branches; in operation, the first and second branches being positioned on either side of the connecting endpiece, the base being in contact with an end of the connecting endpiece that is furthest away from the first end of the conduit.

According to one embodiment, the receptacles are separate and spaced apart from one another.

According to another embodiment, the receptacles are connected to one another.

According to another feature, the receptacles are delimited by an edge-face which describes an undulation over the entire circumference of the conduit or of the connecting endpiece.

It emerges from the foregoing that the positioning of the receptacles on the outer surface opening out at the first end of the conduit facilitates the injection and homogeneous distribution of the adhesive while ensuring optimal coaxial retention during assembly.

This solution makes it possible to obtain, after an assembly method, first and second coaxial axes and a uniform connection system over the circumference of the conduit.

### BRIEF DESCRIPTION OF THE PREFERRED EMBODIMENTS

Further features and advantages will become apparent from the following description of the invention, which description is given solely by way of example, with reference to the appended drawings, in which:

FIG. 1 is a perspective view of part of a pipeline illustrating one embodiment of the prior art,

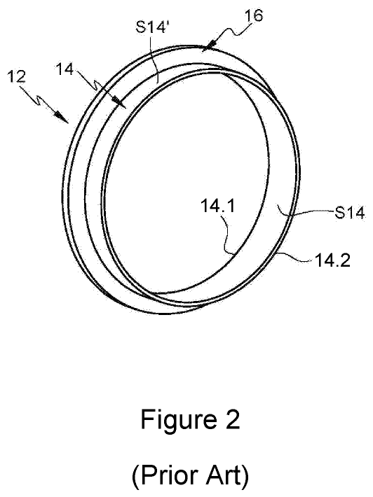

FIG. 2 is a perspective view of a connecting endpiece illustrating one embodiment of the prior art,

FIG. 3 is a cross section of part of the pipeline visible in FIG. 1,

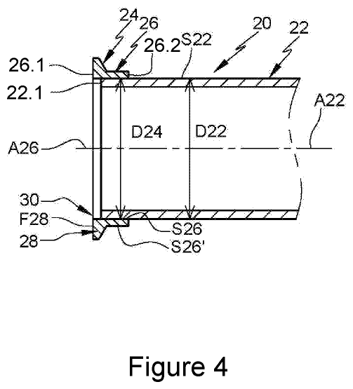

FIG. 4 is a longitudinal cross section of part of a pipeline illustrating one embodiment of the invention,

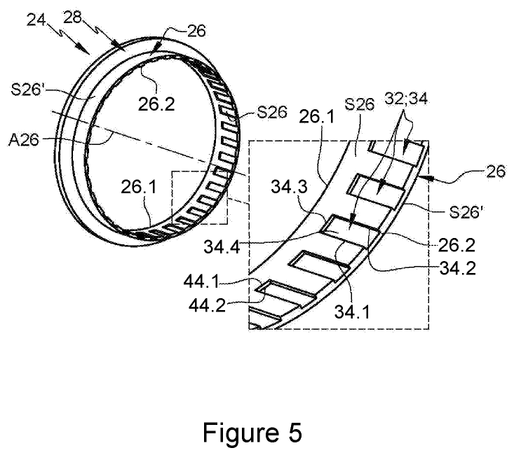

FIG. 5 is a perspective view of a connecting endpiece illustrating one embodiment of the invention,

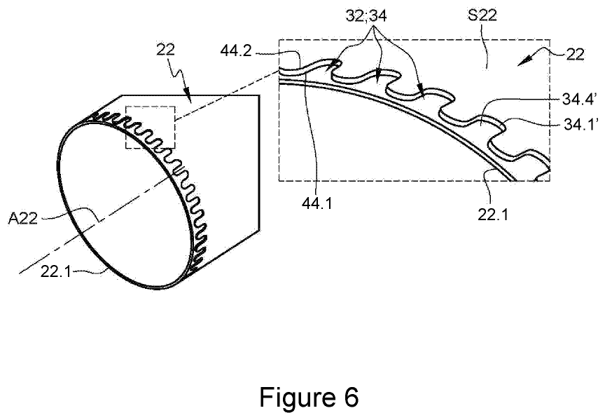

FIG. 6 is a perspective view of part of a conduit illustrating another embodiment of the invention,

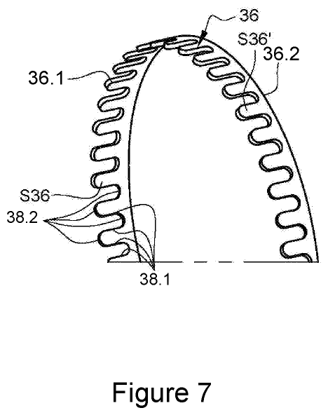

FIG. 7 is a perspective view of a spacer ring of a connection system, connecting a conduit and a spacer endpiece, which illustrates another embodiment of the invention,

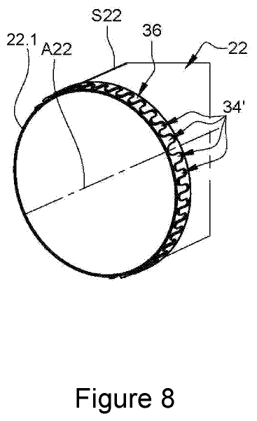

FIG. 8 is a perspective view of the spacer ring, visible in FIG. 7, positioned on a conduit,

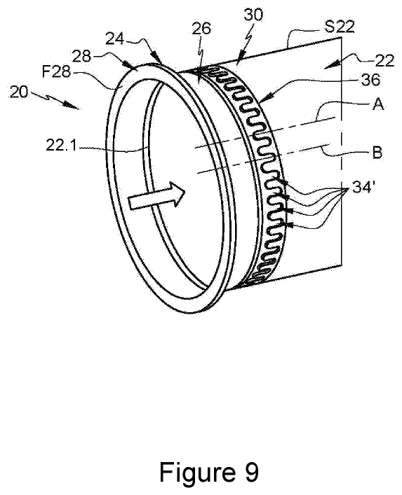

FIG. 9 is a perspective view of the spacer ring and of the conduit visible in FIG. 8 before installation of a connecting endpiece,

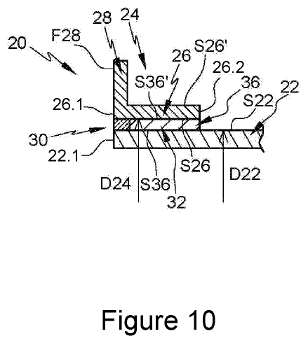

FIG. 10 is a cross section along line A in FIG. 9 after installation of the connecting endpiece,

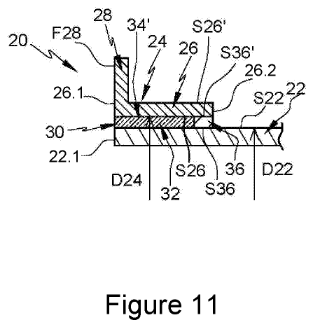

FIG. 11 is a cross section along line B in FIG. 9 after installation of the connecting endpiece,

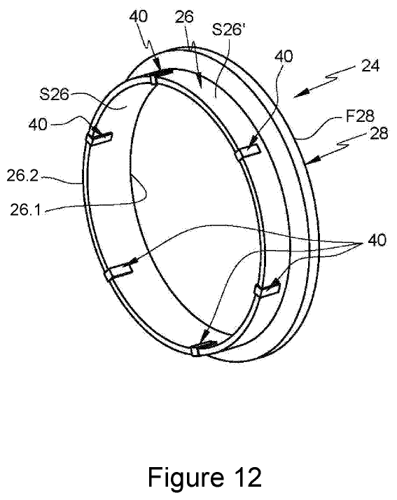

FIG. 12 is a perspective view of a connecting endpiece equipped with spacer elements illustrating another embodiment of the invention,

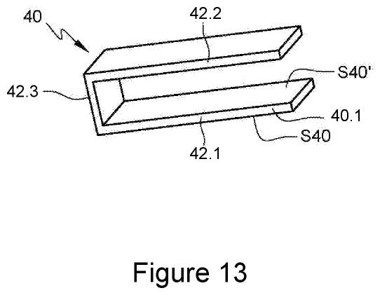

FIG. 13 is a perspective view of a spacer element illustrating one embodiment of the invention,

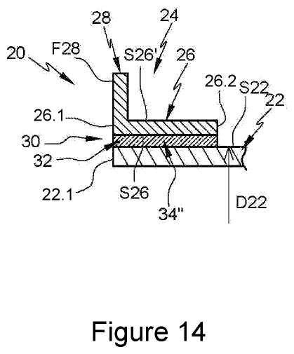

FIG. 14 is a cross section in a first longitudinal plane of part of a pipeline comprising the connecting endpiece and the spacer elements visible in FIG. 12, and,

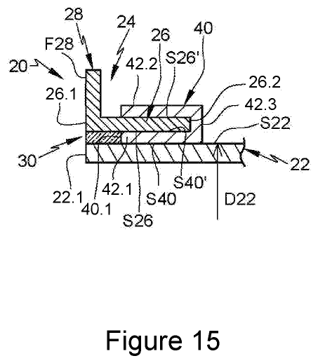

FIG. 15 is a cross section in a second longitudinal plane of part of a pipeline comprising the connecting endpiece and the spacer elements visible in FIG. 12.

### DETAILED DESCRIPTION OF THE PREFERRED EMBODIMENTS

According to one embodiment visible in FIG. 4, a pipeline 20 comprises a conduit 22 which has at least a first end 22.1 and a connecting endpiece 24 located around the conduit 22, at its first end 22.1.

According to one application, the pipeline 20 is used to channel air from an aircraft air conditioning system. Of course, the invention is not limited to this application.

The conduit 22 comprises a cylindrical outer surface S22 which has a first axis A22 and a first diameter D22 at the first end 22.1.

The connecting endpiece 24 comprises:
a sleeve 26 which has a second axis A26, a cylindrical inner surface S26 facing towards the conduit 22 and an outer surface S26′ and extends between first and second ends 26.1, 26.2, and
a collar 28 positioned at the first end 26.1 of the sleeve 26, protruding with respect to the outer surface S26′.

For the remainder of the description, a longitudinal direction is parallel to the first or second axis A22, A26 and a radial direction is perpendicular to the first or second axis A22, A26. A longitudinal plane contains the first or second axis A22, A26 and a transverse plane is perpendicular to the first or second axis A22, A26.

The collar 28 has a contact surface F28 located in the same transverse plane (perpendicular to the second axis A26) as the first end 26.1 of the sleeve 26.

According to one embodiment, the conduit 22 is made of a first material, such as composite material, and the connecting endpiece 24 is made of a second material, different from the first material, such as aluminum alloy. Of course, the invention is not limited to this embodiment. The conduit 22 and the connecting endpiece 24 could be made of the same material.

According to one arrangement, the first end 22.1 of the conduit 22 is located in the same transverse plane as the first end 26.1 of the sleeve 26. In a variant, the first end 26.1 of the sleeve 26 protrudes with respect to the first end 22.1 of the conduit 22.

Whatever the embodiment, the pipeline 20 comprises:
at least one conduit 22 which has a first end 22.1, at least an outer surface S22 and a first axis A22,
at least one connecting endpiece 24, positioned at the first end 22.1 of the conduit 22, which has at least an inner surface S26 facing towards the conduit 22 and a second axis A26, and,
at least one connection system 30 connecting the conduit 22 and the connecting endpiece 24, said connection system 30 comprising at least one region of adhesive 32 interposed between the outer surface S22 of the conduit 22 and the inner surface S26 of the connecting endpiece 24 and in contact with said surfaces.

According to embodiments visible in FIGS. 4, 5 and 6, the inner surface S26 of the connecting endpiece 24 has a second diameter D24 substantially equal to the first diameter D22 of the outer surface S22 of the conduit 22 so as to allow the connecting endpiece 24 to be fitted without play on the conduit 22. Thus, the first and second axes A22, A26 are necessarily substantially coaxial when the connecting endpiece 24 is positioned around the conduit 22.

According to the embodiments visible in FIGS. 4, 5 and 6, at least one surface from among the outer surface S22 of the conduit 22 and the inner surface S26 of the connecting endpiece 24 comprises a plurality of receptacles 34 positioned all the way around the conduit 22, between the conduit 22 and the connecting endpiece 24, and configured to accommodate adhesive so as to form, after said adhesive has cured, regions of adhesive 32.

These various receptacles 34 are regularly distributed all the way around the conduit 22. They are all substantially identical. Thus, the connection system 30 is substantially uniform all the way around the conduit 22.

According to one configuration, all the receptacles 34 open out at an end of the conduit 22 and/or of the connecting endpiece 24.

According to a first variant visible in FIG. 5, the receptacles 34 are separate and spaced apart from one another. Each receptacle 34 forms a notch delimited by two lateral edge-faces 34.1, 34.2 substantially parallel to the first or second axis A22, A26, a transverse edge-face 34.3 connecting the lateral edge-faces 34.1, 34.2 and a bottom 34.4 substantially parallel to the outer or inner surface S22, S26 of the conduit 22 or of the connecting endpiece 24.

According to a second variant visible in FIG. 6, the receptacles 34 are connected to one another. They are delimited by an edge-face 34.1′ which describes an undulation over the entire circumference of the conduit 22 or of the connecting endpiece 24 and by a bottom 34.4′ substantially parallel to the outer or inner surface S22, S26 of the conduit 22 or of the connecting endpiece 24. Of course, the invention is not limited to these two variants for the receptacles 34. The latter may have other forms.

According to a first embodiment visible in FIG. 5, the receptacles 34 are provided at the inner surface S26 of the connecting endpiece 24.

According to one arrangement, the receptacles 34 open out at an end of the connecting endpiece 24 that is furthest away from the first end 22.1 of the conduit 22, more particularly at the second end 26.2 of the sleeve 26.

According to a second embodiment visible in FIG. 6, the receptacles 34 are provided at the outer surface S22 of the conduit 22.

According to one arrangement, the receptacles 34 open out at the first end 22.1 of the conduit 22.

According to embodiments visible in FIGS. 7 to 15, the connection system 30 comprises at least one spacer element 36, interposed between the conduit 22 and the connecting endpiece 24, which has a first surface S36 facing towards the conduit 22 and in contact with the outer surface S22 thereof and a second surface S36′ facing towards the connecting endpiece 24 and in contact with the inner surface S26 thereof.

According to one embodiment visible in FIGS. 7 and 8, the connection system 30 comprises a spacer ring 36, interposed between the conduit 22 and the connecting endpiece 24, which has a first surface S36 facing towards the conduit 22 and in contact with the outer surface S22 thereof and a second surface S36′ facing towards the connecting endpiece 24 and in contact with the inner surface S26 thereof.

This spacer ring 36 extends all the way around the conduit 22 and has a substantially constant thickness over its entire circumference. In operation, since the spacer ring 36 is simultaneously in contact with the conduit 22 and the connecting endpiece 24 and has a substantially constant thickness over its circumference, the first and second axes A22, A26 are necessarily substantially coaxial when the spacer ring 36 is interposed between the conduit 22 and the connecting endpiece 24.

According to one embodiment, the spacer ring 36 is obtained by cutting a strip of material which has a profile identical to that of the spacer ring 36 and a length equal to the circumference of the conduit 22 and then by adhesively bonding the strip of material onto the conduit 22 before fitting the connecting endpiece 24.

The spacer ring 36 extends between first and second edge-faces 36.1, 36.2, the first edge-face 36.1 being closer to the first end 22.1 of the conduit 22 than the second edge-face 36.2, the first and second edge-faces 36.1, 36.2 connecting the first and second surfaces S36, S36′. The first edge-face 36.1 comprises a plurality of notches each forming a receptacle 34′ configured to accommodate adhesive so as to form, after said adhesive has cured, regions of adhesive 32 connecting the conduit 22 and the connecting endpiece 24.

These various receptacles 34′ are regularly distributed all the way around the conduit 22. They are all substantially identical. Thus, the connection system 30 is substantially uniform all the way around the conduit 22.

According to one configuration, the second edge-face 36.2 is positioned in a transverse plane perpendicular to the first and second axes A22, A26. The first edge-face 36.1 alternately comprises rectilinear portions 38.1 and semicircular portions 38.2. According to this configuration, each receptacle 34′ is delimited by two rectilinear portions 38.1 and one semicircular portion 38.2 connecting the two rectilinear portions 38.1. Of course, the invention is not limited to this configuration for the receptacles 34′. The latter may have other forms.

According to another embodiment visible in FIGS. 12 to 15, the connection system 30 comprises multiple spacer elements 40, at least partially interposed between the conduit 22 and the connecting endpiece 24, which each have a first surface S40 facing towards the conduit 22 and in contact with the outer surface S22 thereof and a second surface S40′ facing towards the connecting endpiece 24 and in contact with the inner surface S26 thereof. Each spacer element 40 comprises at least one edge-face 40.1 connecting the first and second surfaces S40, S40′.

The various spacer elements 40 are regularly distributed over the circumference of the conduit 22. By way of example, the connection system 30 comprises six spacer elements 40. Of course, the invention is not limited to this number of spacer elements 40.

The various spacer elements 40 have an identical thickness (dimension measured for each of them between the first and second surfaces S40, S40′). In operation, since the various spacer elements 40 are each simultaneously in contact with the conduit 22 and the connecting endpiece 24 and have the same thickness, the first and second axes A22, A26 are necessarily substantially coaxial when the connecting endpiece 24 and the spacer elements 40 are positioned around the conduit 22.

According to one configuration, the various spacer elements 40 are all identical and each have a U shape. Thus, each spacer element 40 comprises first and second branches 42.1, 42.2 which are substantially parallel to one another and a base 42.3 connecting the first and second branches 42.1, 42.2. In operation, the first and second branches 42.1, 42.2 are positioned on either side of the connecting endpiece 24, the base 42.3 being in contact with an end of the connecting endpiece 24 that is furthest away from the first end 22.1 of the conduit 22, more particularly with the second end 26.2 of the sleeve 26.

The various spacer elements 40, the conduit 22 and the connecting endpiece 24 delimit receptacles 34″ configured to accommodate adhesive so as to form, after said adhesive has cured, regions of adhesive 32 connecting the conduit 22 and the connecting endpiece 24. These various receptacles 34″ are regularly distributed all the way around the conduit 22.

They are all substantially identical. Thus, the connection system 30 is substantially uniform all the way around the conduit 22.

Of course, the invention is not limited to these embodiments for the connection system 30. Whatever the embodiment, the connection system 30 comprises at least one receptacle 34, 34′, 34″ positioned between the conduit 22 and the connecting endpiece 24, around the conduit 22, and configured to accommodate a region of cured adhesive 32 connecting the conduit 22 and the connecting endpiece 24. Each receptacle 34, 34′, 34″ is delimited by at least one edge-face 34.1, 34.2, 34.3, 34.1′, 38.1, 40.1 incorporated into at least one element from among the conduit 22, the connecting endpiece 24 and said at least one spacer element 36, 40.

According to one arrangement, each edge-face 34.1, 34.2, 34.3, 34.1′, 38.1, 40.1 comprises a first edge 44.1 which is slightly spaced apart from or forms part of the conduit 22 and a second edge 44.2, radially offset with respect to the first edge 44.1, which is slightly spaced apart from or forms part of the connecting endpiece 24. For the present invention, it is considered that two elements are slightly spaced apart if these elements are spaced apart by a distance of less than one tenth of a millimeter.

According to one embodiment, the connection system comprises a plurality of receptacles 34, 34′, 34″ regularly distributed around the conduit 22. The edge-faces 34.1, 34.2, 34.3, 34.1′, 38.1, 40.1 of the various receptacles 34, 34′, 34″ have substantially the same height (dimension measured in a radial direction). This solution makes it possible to obtain a uniform connection system 30 over the circumference of the conduit. Generally, the receptacles are substantially identical.

According to first embodiments, the outer and inner surfaces S22, S26 of the conduit 22 and of the connecting endpiece 24 have substantially identical diameters. According to these first embodiments, the edge-faces 34.1, 34.2, 34.3, 34.1′ of the various receptacles 34, 34′, 34″ are incorporated in the region of the conduit 22 and/or of the connecting endpiece 24, the receptacles 34 being provided at the inner surface S26 of the connecting endpiece 24 and/or the outer surface S22 of the conduit 22.

According to second embodiments, the connection system 30 comprises at least one spacer element 36, 40, at least partially interposed between the conduit 22 and the connecting endpiece 24, configured so as to retain the coaxial first and second axes A22, A26. According to these second embodiments, the edge-faces 38.1, 40.1 of the various receptacles 34, 34′, 34″ are incorporated in the region of the spacer element(s) 36, 40. These second embodiments are more particularly suitable for existing pipelines which each comprise a conduit with a smooth outer surface (without receptacles) and a connecting endpiece with a smooth inner surface (without receptacles) having a diameter greater than that of the outer surface of the conduit.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A pipeline comprising:
a conduit which has a first end, an outer surface, and a first axis;
an connecting endpiece positioned at the first end of the conduit, the connecting endpiece having an inner surface facing towards the conduit and a second axis; and,
a connection system connecting the conduit and the connecting endpiece and comprising a receptacle positioned between the conduit and the connecting endpiece, around the conduit, the receptacle configured to accommodate a region of adhesive connecting the conduit and the connecting endpiece,
wherein the outer surface of the conduit and the inner surface of the connecting endpiece have substantially a same diameter or the connection system comprises a spacer ring interposed between the conduit and the connecting endpiece, the spacer ring extending all the way around the conduit and having a substantially constant thickness, a first surface facing towards the conduit and in contact with the outer surface, and a second surface facing towards the connecting endpiece and in contact with the inner surface, and
wherein the receptacle of the connection system comprises a plurality of receptacles regularly distributed around the conduit, provided at the outer surface of the conduit and opening out at the first end of the conduit, each receptacle of the plurality of receptacles delimited by an edge-face incorporated into at least one element selected from the conduit, the connecting endpiece, and the spacer ring.

2. The pipeline according to claim 1, wherein the plurality of receptacles are separate and spaced apart from one another.

3. The pipeline according to claim 1, wherein the plurality of receptacles are connected to one another.

4. The pipeline according to claim 3, wherein the edge-faces of the plurality of receptacles form an undulation over an entire circumference of the conduit or the connecting endpiece.

5. A pipeline comprising:
a conduit which has a first end, an outer surface, and a first axis;
a connecting endpiece positioned at the first end of the conduit and which has an inner surface facing towards the conduit and a second axis; and,
a connection system connecting the conduit and the connecting endpiece and comprising a receptacle positioned between the conduit and the connecting endpiece, around the conduit, the receptacle configured to accommodate a region of adhesive connecting the conduit and the connecting endpiece,
wherein the outer surface of the conduit and the inner surface of the connecting endpiece having substantially a same diameter or the connection system comprises a spacer element at least partially interposed between the conduit and the connecting endpiece and having a first surface facing towards the conduit and in contact with the outer surface and a second surface facing towards the connecting endpiece and in contact with the inner surface,
wherein the receptacle is delimited by an edge-face incorporated into at least one element selected from the conduit, the connecting endpiece, and the spacer element, and,
wherein the receptacle is provided at the outer surface of the conduit and opens out at the first end of the conduit.

6. The pipeline according to claim 5, wherein the receptacle of the connection system comprises a plurality of receptacles regularly distributed around the conduit.

7. The pipeline according to claim 6, wherein the plurality of receptacles are provided at the inner surface of the connecting endpiece, or the outer surface of the conduit, or both.

8. The pipeline according to claim 7, wherein the plurality of receptacles are provided at the inner surface of the connecting endpiece and open out at an end of the connecting endpiece that is furthest away from the first end of the conduit.

9. The pipeline according to claim 6, wherein the spacer element comprises a spacer ring interposed between the conduit and the connecting endpiece, the spacer ring extending around an entirety of a circumference of the conduit, having a substantially constant thickness, and further having a first surface facing towards the conduit and in contact with the outer surface and a second surface facing towards the connecting endpiece and in contact with the inner surface.

10. The pipeline according to claim 6, wherein the spacer element comprises a plurality of spacer elements which each have a first surface facing towards the conduit and in contact with the outer surface and a second surface facing towards the connecting endpiece and in contact with the inner surface,
wherein the plurality of spacer elements have an identical thickness.

11. The pipeline according to claim 10, wherein each spacer element of the plurality of spacer elements comprises a first branch, a second branch substantially parallel to the first branch, and a base connecting the first branch and the second branch,
wherein the first branch and the second branch are positioned on either side of the connecting endpiece, and the base in contact with an end of the connecting endpiece that is furthest away from the first end of the conduit.

12. The pipeline according to claim 6, wherein the plurality of receptacles are separate and spaced apart from one another.

13. The pipeline according to claim 6, wherein the plurality of receptacles are connected to one another.

14. The pipeline according to claim 13, wherein the plurality of receptacles are each delimited by an edge-face, and
wherein the edge-faces of the plurality of receptacles form an undulation over an entire circumference of the conduit or the connecting endpiece.
